(19) United States
(12) Patent Application Publication
(10) Pub. No.: US 2025/0111300 A1
(43) Pub. Date: Apr. 3, 2025

(54) SYSTEM AND METHOD FOR ELECTRONICALLY PRESCRIBING TASK SESSIONS

(71) Applicant: Steward Health Care Investors LLC, Dallas, TX (US)

(72) Inventor: Ralph de la Torre, Dallas, TX (US)

(73) Assignee: Steward Health Care Investors LLC, Dallaas, TX (US)

(21) Appl. No.: 18/902,391

(22) Filed: Sep. 30, 2024

Related U.S. Application Data
(60) Provisional application No. 63/541,600, filed on Sep. 29, 2023.

(51) Int. Cl. G06Q 10/0631

(52) U.S. Cl. CPC G06Q 10/063112

(57) ABSTRACT

A computer implemented method and system for electronically prescribing a user defined task session to a third party via a communication network. A task session is defined by a user, via user interaction with a user's computer device, which is transmitted, via the communication network, so as to be received in a remote computer server. The computer server subsequently transmits, via the communication network, the user prescribed task session to a designated third party. An electronic device associated with the designated third party receives the transmitted task session, wherein in at least a portion of the task session to be initiated by the third party is displayed to the designated third party via the designated third party's electronic device. Preferably, the designated third party's electronic device includes one or more components for evidencing the prescribed task session has been initiated, and completed, by the third party. Once a task session has been completed, a notification signal is transmitted from the electronic device associated with the third party to the remote computer server, via the communication network, evidencing the prescribed task session has been initiated and completed. The computer server then transmits a notification signal to the user's computer device, via the communication network, evidencing initiation and completion of the prescribed task session by the designated third party.

### CROSS REFERENCE TO RELATED APPLICATIONS

This application claims priority to U.S. Patent Application Ser. No. 63/541,600 filed Sep. 29, 2023, which is incorporated herein by reference in its entirety.

### FIELD OF THE INVENTION

The illustrated embodiments generally relate to systems, methods and apparatuses for electronically prescribing task sessions for initiation by one or more third parties, and more particularly to utilizing Artificial Intelligence (AI) and Machine Learning (ML) techniques for determining a third party to initiate a task session and/or determine successful completion of a task session by a third party.

### BACKGROUND OF THE INVENTION

There currently exists a need for an electronic system configured to securely, and rapidly, provide the ability for a user to prescribe a task session (e.g., confirming a home's front door is locked, garage door is shut, etc.) to be initiated by a certain third party. There also exists a need to utilize AI/ML technologies to determine a proper third party to initiate a prescribed task session as well as determine when a prescribed task session has successfully be completed by a certain third party.

### SUMMARY OF THE INVENTION

The purpose and advantages of the illustrated embodiments will be set forth in and apparent from the description that follows. Additional advantages of the illustrated embodiments will be realized and attained by the devices, systems and methods particularly pointed out in the written description and claims hereof, as well as from the appended drawings.

Generally, described herein, in one aspect is a computer system, method and/or apparatus configured to electronically prescribe a user defined task session to a third party via a communication network. A task session is defined by a user, via user interaction with a user's computer device, which is transmitted, via the communication network, so as to be received in a remote computer server. The computer server subsequently transmits, via the communication network, the user prescribed task session to a designated third party. An electronic device associated with the designated third party receives the transmitted task session, wherein in at least a portion of the task session to be initiated by the third party is displayed to the designated third party via the designated third party's electronic device. Preferably, the designated third party's electronic device includes one or more components for evidencing the prescribed task session has been initiated, and completed, by the third party. Once a task session has been completed, a notification signal is transmitted from the electronic device associated with the third party to the remote computer server, via the communication network, evidencing the prescribed task session has been initiated and completed. The computer server preferably then transmits a notification signal to the user's computer device, via the communication network, evidencing initiation and completion of the prescribed task session by the designated third party.

In other aspects, the computer server is configured to determine a third party to be designated for receiving the prescribed task session from the computer server, wherein the computer server is configured to use Artificial Intelligence (AI)/Machine Learning (ML) techniques to determine a third party to be designated for receiving the prescribed task session from the computer server. In certain embodiments, a trained neural network determines a third party to be designated for receiving the prescribed task session from the computer server. In other embodiments, the computer server is further configured to utilize AI/ML to determine if a task session has been successfully completed by a third party. In certain illustrated embodiments, a software application (app) is loaded on each of the portable computer devices of the user and third party, for enabling communication with the remote computer sever regarding initiation of user prescribed tasks sessions.

### BRIEF DESCRIPTION OF THE DRAWINGS

The accompanying appendices and/or drawings illustrate various, non-limiting, examples, inventive aspects in accordance with the present disclosure:

FIG. 1 illustrates an example communication network utilized with one or more of the illustrated embodiments;

FIG. 2 illustrates an example network device/node utilized with one or more of the illustrated embodiments;

FIG. 3 illustrates a diagram depicting an Artificial Intelligence (AI) device utilized with one or more of the illustrated embodiments;

FIG. 4 illustrates a diagram depicting an AI server utilized with one or more of the illustrated embodiments; and

FIG. 5 is a flow diagram illustrating an exemplary computer implemented method for electronically prescribing a task session in accordance with the illustrated embodiments of FIGS. 1-4.

### DETAILED DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program for preferably electronically prescribing a user defined task session for initiation by a third party. In accordance with the illustrated embodiments, machine learning techniques are preferably utilized for various aspects relating to the computer process for electronically prescribing a user defined task session for initiation by a third party, such as determining one or more third parties to be assigned a user prescribed task session and/or determining whether a prescribed task session has been properly completed by an assigned third party.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

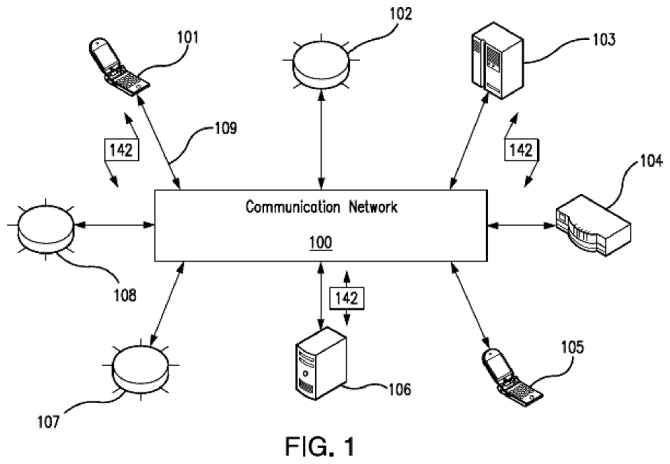

Turning now descriptively to the drawings, in which similar reference characters denote similar elements throughout the several views, FIG. 1 depicts an exemplary communications network 100 in which below illustrated embodiments may be implemented. It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, client computing devices 103 (e.g., network monitoring devices), smart phone devices 101, 105, web servers 106, routers 107, switches 108, databases, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the illustrated embodiments may be embodied as a system, method or computer program product. Accordingly, aspects of the illustrated embodiments may take the form of an entirely hardware embodiment, an entirely software embodiment (including firmware, resident software, micro-code, etc.) or an embodiment combining software and hardware aspects that may all generally be referred to herein as a “device”, “apparatus”, “module” or “system.” Furthermore, aspects of the illustrated embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++, Python, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the illustrated embodiments are described below with reference to flowchart illustrations and/or block diagrams of methods, apparatus (systems) and computer program products according to the illustrated embodiments. It will be understood that each block of the flowchart illustrations and/or block diagrams, and combinations of blocks in the flowchart illustrations and/or block diagrams, can be implemented by computer program instructions. These computer program instructions may be provided to a processor of a computer device, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

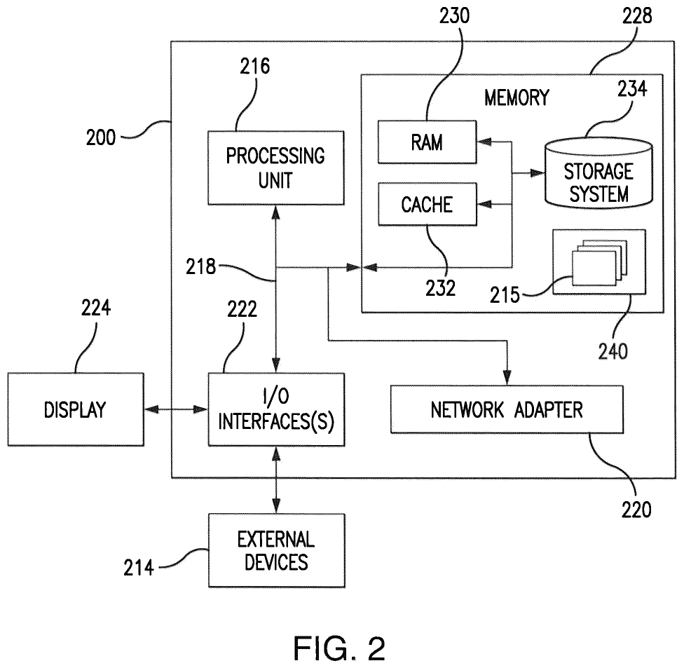

FIG. 2 is a schematic block diagram of an example network computing device 200 (e.g., client computing device 103, server 106, etc.) that may be used (or components thereof) with one or more embodiments described herein (e.g., as one of the nodes shown in the network 100) for electronically prescribing a user defined task session for initiation by a third party. As explained above, in different embodiments these various devices are configured to communicate with each other in any suitable way, such as, for example, via communication network 100.

Device 200 is intended to represent any type of computer system capable of carrying out the teachings of various illustrated embodiments. Device 200 is only one example of a suitable system and is not intended to suggest any limitation as to the scope of use or functionality of the illustrated embodiments described herein. Regardless, computing device 200 is capable of being implemented and/or performing any of the functionality set forth herein, particularly for electronically prescribing a user defined task session for initiation by a third party.

It is to be understood and appreciated that computing device 200 is operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, network PCs, minicomputer systems, and distributed data processing environments that include any of the above systems or devices, and the like. Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network 100. In a distributed data processing environment, program modules may be located in both local and remote computer system storage media including memory storage devices.

The components of device 200 may include, but are not limited to, one or more processors or processing units 216, a system memory 228, and a bus 218 that couples various system components including system memory 228 to processor 216. Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random-access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk, and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of illustrated embodiments such as electronically prescribing a user defined task session for initiation by a third party, and in certain embodiments, through implementation of machine learning (ML) techniques.

Program/utility 240, having a set (at least one) of program modules 215, such as underwriting module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of the illustrated embodiments as described herein for electronically prescribing a user defined task session for initiation by a third party 105.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which the below described illustrated embodiments may be implemented. FIGS. 1 and 2 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

It is to be understood that certain embodiments described herein are preferably provided with Machine Learning (ML)/Artificial Intelligence (AI) techniques for electronically prescribing a user defined task session for initiation by a third party through implementation of machine learning (ML) techniques. The computer system 200 is preferably integrated with an AI system (as also described below) that is preferably coupled to a plurality of external databases/data sources that implements machine learning and artificial intelligence algorithms in accordance with the illustrated embodiments. For instance, the AI system may include two subsystems: a first sub-system that learns from historical data; and a second subsystem to identify and recommend one or more parameters or approaches based on the learning for detecting anomaly events in computer devices. It should be appreciated that although the AI system may be described as two distinct subsystems, the AI system can also be implemented as a single system incorporating the functions and features described with respect to both subsystems.

In accordance with the illustrated embodiments described herein, artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task (e.g., detecting data anomalies) through a steady experience with the certain task.

Also in accordance with certain illustrated embodiments, a neural network (NN) may be used as the trained ML model for prescribing a user defined task session for initiation by a third party, including determining one or more third parties to be assigned a user prescribed task session and/or determining when a prescribed task session has been properly completed by an assigned third party. It is to be appreciated that a neural network is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value. The artificial neural network preferably includes an input layer, an output layer, and one or more hidden layers. Each layer includes one or more neurons, and the artificial neural network may include a synapse that links neurons to neurons. In the artificial neural network, each neuron may output the function value of the activation function for input signals, weights, and deflections input through the synapse.

It is to be understood and appreciated that model parameters refer to parameters determined through learning and include a weight value of synaptic connection and deflection of neurons. A hyperparameter means a parameter to be set in the machine learning algorithm before learning, and typically includes a learning rate, a repetition number, a mini batch size, and an initialization function. The purpose of the learning of the neural network may be to determine the model parameters that minimize a loss function. The loss function may be used as an index to determine optimal model parameters in the learning process of the neural network. Machine learning may be classified into supervised learning, unsupervised learning, and reinforcement learning according to a learning method. The supervised learning may refer to a method of learning a neural network in a state in which a label for learning data is given, and the label may mean the correct answer (or result value) that the neural network must infer when the learning data is input to the artificial neural network. The unsupervised learning may refer to a method of learning a neural network in a state in which a label for learning data is not given. The reinforcement learning may refer to a learning method in which an agent defined in a certain environment learns to select a behavior or a behavior sequence that maximizes cumulative compensation in each state.

Is it to also be appreciated that machine learning, which is implemented as a deep neural network (DNN) including a plurality of hidden layers among neural networks, is also referred to as deep learning, and the deep learning is part of machine learning.

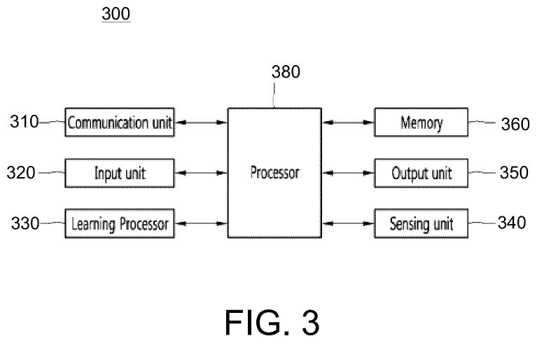

Referring now to FIG. 3, it illustrates an Artificial Intelligence (AI) monitoring device 300 according to an embodiment of the illustrated embodiments. The AI monitoring device 300 may be implemented by a stationary device or a mobile device, such as a web server, a desktop computer, a notebook, a desktop computer, and the like.

In conjunction with FIGS. 1 and 2, FIG. 3 illustrates the AI monitoring device 300 operatively coupled to, or integrated with computing device 200, in accordance with the illustrated embodiments described herein. AI monitoring device 300 preferably includes a communication unit 310, an input unit 320, a learning processor 330, a sensing unit 340, an output unit 350, a memory 360, and a processor 380. The communication unit 310 may transmit and receive data to and from external devices, such as other AI devices, by using wire/wireless communication technology. For example, the communication unit 310 may transmit and receive historical and contemplated application change variables, a user input, a learning model, and a control signal to and from external devices, such as AI server 400.

The communication technology used by the communication unit 310 preferably includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

In accordance with the illustrated embodiments, the input unit 320 may acquire various kinds of data, including, but not limited to data relating to third parties for initiating a task session and data relating to determining whether a task session has been properly completed by a third party. The input unit 320 may acquire learning data for model learning (e.g., historical data related to certain application change variables) and input data (e.g., contemplated application change variables) to be used when an output is acquired by using a learning model. The input unit 320 may acquire raw input data. In this case, the processor 380 or the learning processor 330 may extract an input feature by preprocessing the input data. In certain embodiments, the learning processor 330 learns (trains) a ML model by using learning data for determining the probability of incident occurrence to one or more applications resulting from one or more application change variables. The ML model in certain embodiments infers a result value for new input data rather than learning data, and the inferred value may be used as a basis for determination to perform a certain operation.

In certain illustrated embodiments, the learning processor 330 performs AI processing together with the learning processor 440 of the AI server 400, and the learning processor 330 may include a memory integrated or implemented in the AI monitoring device 300. Alternatively, in other illustrated embodiments, the learning processor 330 is implemented by using the memory 360, an external memory directly connected to the AI monitoring device 300, or a memory held in an external device.

The output unit 350 preferably includes a display unit for outputting/displaying relevant information to a user in accordance with the illustrated embodiments described herein. The memory 360 preferably stores data that supports various functions of the AI monitoring device 300. For example, the memory 360 may store input data acquired by the input unit 320, learning data, a learning model, a learning history, and the like.

The processor 380 preferably determines at least one executable operation of the AI monitoring device 300 based on information determined or generated by using a data analysis algorithm or a machine learning algorithm. The processor 380 may control the components of the AI monitoring device 300 to execute the determined operation. To this end, the processor 380 may request, search, receive, or utilize time-based metric data of the learning processor 330 or the memory 360. The processor 380 may control the components of the AI monitoring device 300 to execute the predicted operation or the operation determined to be desirable among the at least one executable operation. When the connection of an external device is required to perform a determined operation, the processor 380 may generate a control signal for controlling the external device and may transmit the generated control signal to the external device. The processor 380 may acquire intention information for the user input and may determine the user's requirements based on the acquired intention information. In some embodiments, the processor 380 may acquire the intention information corresponding to the user input by using at least one of a speech to text (STT) engine for converting speech input into a text string or a natural language processing (NLP) engine for acquiring intention information of a natural language.

In certain illustrated embodiments, at least one of the STT engine or the NLP engine may be configured as an artificial neural network, at least part of which is learned according to the machine learning algorithm. Thus, in certain illustrated embodiments, at least one of the STT engine or the NLP engine may be learned by the learning processor 330, or may be learned by the learning processor 340 of the AI server 400, or may be learned by their distributed processing. The processor 380 may collect history information including the operation contents of the AI monitoring device 300 or the user's feedback on the operation and may store the collected history information in the memory 360 or the learning processor 330 or transmit the collected history information to the external device such as the AI server 400. The collected history information may be used to update the learning model.

The processor 380 may control at least part of the components of AI monitoring device 300 so as to drive an application program stored in memory 360. Furthermore, the processor 380 may operate two or more of the components included in the AI monitoring device 300 in combination so as to drive the application program.

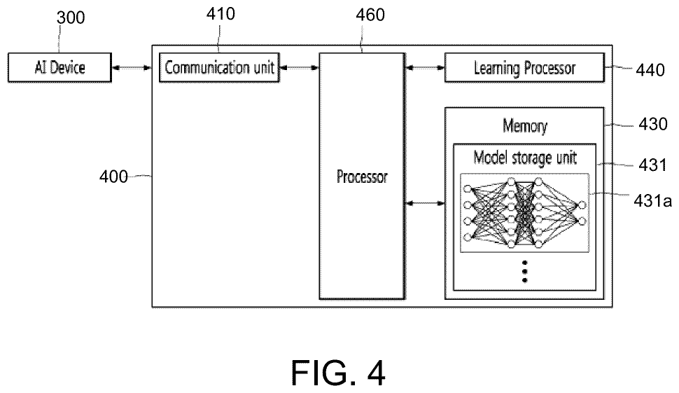

FIG. 4 illustrates an AI server 400 according to the certain illustrated embodiments that may utilize a neural network for ML. It is to be appreciated that the AI server 400 may refer to a device that learns an artificial neural network by using a machine learning algorithm or uses a learned artificial neural network. The AI server 400 may include a plurality of servers to perform distributed processing, or may be defined as a 5G network. Preferably, the AI server 400 is included as a partial configuration of the AI monitoring device 300, and performs at least part of the AI processing together. The AI server 400 may include a communication unit 410, a memory 430, a learning processor 440, a processor 460, and the like. The communication unit 410 can transmit and receive data to and from an external device such as the AI monitoring device 300. The memory 430 may include a model storage unit 431. The model storage unit 431 may store a learning or learned model (or a neural network 431a) through the learning processor 440.

The learning processor 440 may learn the artificial neural network 431a by using the learning data. The learning model may be used in a state of being mounted on the AI server 400 of the neural network or may be used in a state of being mounted on an external device such as the AI monitoring device 300. The learning model may be implemented in hardware, software, or a combination of hardware and software. If all or part of the learning models are implemented in software, one or more instructions that constitute the learning model may be stored in memory 430. The processor 460 may infer the result value for new input data by using the learning model and may generate a response or a control command based on the inferred result value.

It is to be understood and appreciated that FIGS. 1-4 are intended to provide a brief, general description of an illustrative and/or suitable exemplary environment in which the below described illustrated embodiments may be implemented. FIGS. 1-4 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

With the exemplary communication network 100 (FIG. 1), computing device 200 (FIG. 2), AI monitoring device 300 (FIG. 3) and AI server 400 (FIG. 4) being generally shown and discussed above, description of certain illustrated embodiments will now be provided. It is to be understood and appreciated that exemplary embodiments implementing one or more components of FIGS. 1-4 in one aspect relate to a computer application product 240 for electronically prescribing a user defined task session for initiation by a third party 105, via a communication network 100. A user application component 240 is preferably provided on a user's device 101 configured to enable a user to prescribe a task session, via user interaction with the user's computer device 101, to be initiated by a third party 105. The prescribed task session is sent from the user's device 101, via network 100, to preferably a remote computer server 106, via the communication network 100. A server application component 240 is preferably provided on the remote computer server 106 that enables the prescribed task session to be transmitted from the remote computer server 106, via the communication network 100, to a device associated with a designated third party 105 for performing the prescribed task session. A cooperating task initiator application component 240 is preferably provided on the third party's computer device 105 enabling reception of the prescribed task session in the third party's computer device 105, that was transmitted from the remote computer server 106, via the communication network 100. In certain embodiments, displayed on the third party's computer device 105 is at least a portion of the prescribed task session to be initiated. Preferably, the third party's computer device 105 captures data evidencing the prescribed task session has been initiated by the third party, which is then preferably transmitted, preferably in a notification signal, via communication network 100, to the remote computer server 106 indicating the prescribed task session has been completed. The computer server 106 then communicates with the user device 101 indicating the task session prescribed by the user of device 101 has been completed.

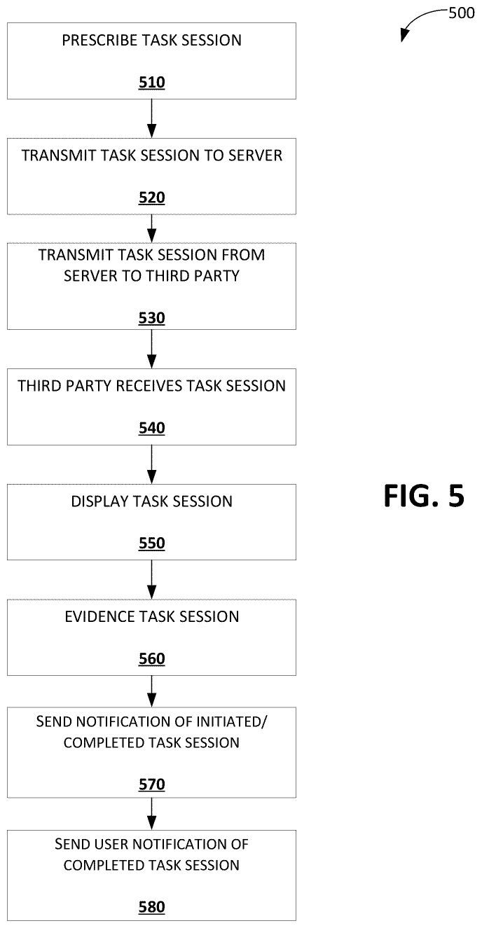

With specific reference now to FIG. 5 (and with continuing reference to FIGS. 1-4), an illustrative process (referenced generally by 500) for implementing electronically prescribing a user defined task session for initiation by a third party 105, via a communication network 100, will now be described. Starting at step 510, a task session is electronically prescribed by a user, via user interaction with a user's computer device 101, to be initiated by a third party (e.g., 105), wherein the task session requests a third party (e.g., 105) to be designated for receiving the prescribed task session from a computer server (e.g., 106). It is to be appreciated and understood the user computer device is preferably a computer device 101, such as (but not limited to): a smart phone device; tablet device, desktop and laptop device. Additionally the prescribed task session in certain embodiments consists of a plurality of tasks bundled in a task session sent to the remote computer server (106, as described further below). For instance, illustrative examples of a prescribed task session include (but are not limited to): prescribing by a user (101) one or more pictures and/or videos to be taken, such as at specific location (such as a residential address) and or a specific part of a location (e.g., a front door of a residential address); and prescribing by a user a written description of a task session to be initiated and/or the means provided by the computer device of the third party for evidencing the prescribed task session has been initiated by the third party (e.g., enabling the third party to input a written description evidencing the task has been initiated). Additionally, the task session may include prescribing by the user the identification of a specific location for a defined task to be initiated, which may include one or more of: 1) defining a task accompanied with relevant details including acquiring a certain number of pictures and/or videos of one or more areas of one or more locations; 2) defining an area of specific location from one or more of a drop down menu or via user character-limited input facilitated by the user computer device 101; 3) user selection of media confirmation including, but not limited to, taking one or more photographs and/or a recording a video of a specified time duration by a third party device 105; 4) user prescribed actions to perform specific to a certain area at the location; and 5) prescribing additional areas at the location to perform one or more certain actions. Additionally, in certain embodiments, the prescribed task session includes a prescribed time period, which duration may be variable based on specifics of task(s) requested for a task session, for completing a task session. Still further, in certain embodiments, the user 101 is enabled to provide follow-up requests relating to a prior prescribed task session(s) and/or including additional tasks to be initiated for a certain task session, subsequent to the certain task session being prescribed for initiation by a third party 105.

Next, at step 520 the aforesaid prescribed task session is transmitted (preferably via an application (e.g., an “app”) executing in the user's device 101) from the user's device 101, via the communication network 100, to a remotely located networked coupled computer device, such as a computer server 106. In accordance the illustrated embodiments, the computer server 106 is preferably configured to store in a database accessible by a third party task session initiator 101 certain details relating to a completed initiated task session by a third party 105, which may include one or more of: 1) date, start time, end time, duration each task session; 2) location areas associated with each task session; 3) task actions requested; 4) number of photos/videos uploaded for each task session; and 5) confirmation of completion from the third party task initiator. Once the prescribed task session is received in the remote computer server 106 (step 520), next at step 530, the remote computer server 106 preferably transmits the prescribed task session (which may include a bundled plurality of tasks) to a designated third party 105. Preferably, a software application is loaded for execution on the computer device 106 for enabling communication with user devices (e.g., 101 and 105), preferably via one or more communication networks 100. In certain illustrated embodiments, the computer server 106 is preferably configured to determine a third party 105 to be designated for receiving the prescribed task session from the computer server 106. For instance, for determining a third party 105 to be designated for initiating a task session (step 510), the computer server 106 in certain embodiments is configured to use Artificial Intelligence (AI)/Machine Learning (ML) techniques to determine a third party 105 to be designated for receiving the prescribed task session (step 510) from the computer server 106. In certain embodiments, the computer server 106 trains and utilizes a trained neural network to determine a third party 105 to be designated for receiving the prescribed task session (step 510) from the computer server 106.

Once the prescribed task session is transmitted from the computer server 106 to one or more designated recipients (step 530), next at step 540, one or more designated recipients 105 receive the prescribed task session via one or more communication networks 100. Next, at step 550, once received in a designated third party device 105, at least a portion of the task session to be initiated by the designated third party is displayed on an electronic device 105 associated with the third party (e.g., such as (but not limited to): a smart phone device; tablet device and laptop device). Next, at step 560, preferably once the prescribed task session has been initiated and completed by the one or more designated third parties 105, the electronic devices associated with the one or more designated third parties 105 preferably capture data evidencing the prescribed task session has been completed. In accordance with certain illustrated embodiments, a third party electronic device 105 preferably includes one or more components for evidencing the prescribed task session has been initiated by the third party 105, which for instance may include a camera component for recording one or more pictures and/or videos, such as at a specific location and or a specific part of a location. In certain illustrated embodiments, the third party computer device 105 is configured to be prevented from storing on local memory data (e.g., pictures and/or videos recorded) relating to a prescribed task session, wherein the third party computer device 105 is further preferably configured to remove from memory of the user computer device 105 any pictures and/or videos recorded relating to initiation of a prescribed task upon completion of a task session.

Next, at step 570, the electronic device 105 of the designated third party transmits a notification signal to the remote computer server 106, via the communication network 100, evidencing the prescribed task session has been initiated. In accordance with certain illustrated embodiments, the computer server 106 is preferably configured to determine (e.g., verify) if a task session has been successfully completed by a third party 105. For instance, the computer server 106 in certain embodiments is configured to use Artificial Intelligence (AI)/Machine Learning (ML) to determine if a task session has been successfully completed by a third party, wherein the computer server 106 trains, and utilizes a trained neural network to determine if a task session has been successfully completed by a third party 105.

Once the prescribed task session has been determined to be completed by the designated third party (step 570), next at step 580, a notification signal is preferably transmitted from the remote computer server 106, via the communication network 100, to the user's device 101 evidencing completion of the prescribed task session by the designated third party 105. In accordance with certain illustrated embodiments, the computer server 106 is preferably further configured to initiate an electronic payment process enabling electronic payment from a user 101 to a designated third party task initiator preferably once the task session has been determined successfully completed (step 570). In certain embodiments, the computer server 106 is configured to automatically initiate payment to a third party task initiator 105 upon completion of a task session by the third party task initiator 105.

With the certain illustrated embodiments described above, descriptions of the various embodiments of the illustrated embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for electronically prescribing a user defined task session to a third party via a communication network, comprising the steps:
prescribing a task session by a user, via user interaction with a user's computer device, to be initiated by a third party;
receiving in a remote computer server, via the communication network, the user prescribed task session;
sending from the remote computer server, via the communication network, the user prescribed task session to a designated third party;
receiving in a computer device associated with the designated third party, via the communication network, the prescribed task session to be initiated wherein the computer device associated with the third party is configured to:
display at least a portion of the prescribed task session to be initiated;
provide means for evidencing the prescribed task session has been initiated by the third party;
send a notification signal to the remote computer server, via the communication network, evidencing the prescribed task session has been initiated; and
receiving in the user's computer device a signal from the remote computer server, via the communication network, evidencing initiation of the prescribed task session by the designated third party responsive to the notification signal being received in the remote computer server.

2. The computer-method as recited in claim 1, wherein a user prescribes a plurality of tasks bundled in a task session sent to the remote computer server.

3. The computer-implemented method as recited in claim 2, wherein the bundled plurality of tasks are sent to a plurality of third parties by the remote computer server whereby a third party from the plurality of third parties performs one or more of the bundled tasks for initiation thereof.

4. The computer-implemented method as recited in claim 1, wherein the user prescribes a third party to be designated for receiving the prescribed task session from the computer server.

5. The computer-implemented method as recited in claim 1, wherein the computer server is configured to determine a third party to be designated for receiving the prescribed task session from the computer server.

6. The computer-implemented method as recited in claim 1, wherein the computer server utilizes one or more Artificial Intelligence (AI) techniques to determine a third party to be designated for receiving the prescribed task session from the computer server.

7. The computer-implemented method as recited in claim 1, wherein the computer server is configured to determine if a task session has been successfully completed by a third party.

8. The computer-implemented method as recited in claim 7, wherein the computer server utilizes one or more Artificial Intelligence (AI) techniques to determine if a task session has been successfully completed by a third party.

9. The computer-implemented method as recited in claim 1, wherein the task session prescribed by the user includes one or more pictures and/or videos to be taken.

10. The computer-implemented method as recited in claim 1, wherein the task session prescribed by the user includes a written description of the task session to be initiated and/or the means provided by the computer device of the third party for evidencing the prescribed task session has been initiated by the third party includes enabling the third party to input a written description evidencing the task has been initiated.

11. The computer-implemented method as recited in claim 1, wherein the user is enabled to provide follow-up requests relating to prior prescribed task session and/or including additional tasks to be initiated for a certain task session, subsequent to the certain task session being prescribed for initiation by a third party.

12. The computer-implemented method as recited in claim 9, wherein the third party computer device is configured to be prevented from storing on local memory of the user computer device any pictures and/or videos recorded relating to initiating a prescribed task.

13. The computer-implemented method as recited in claim 12, wherein the third party computer device is configured to remove from memory of the user computer device any pictures and/or videos recorded relating to initiation of a prescribed task upon completion of a task session.

14. The computer-implemented method as recited in claim 1, wherein the user has a prescribed time period, which duration may be variable based on specifics of task(s) requested for a task session, for completing a task session.

15. The computer-implemented method as recited in claim 1, wherein the computer server is further configured to store in a database accessible by a third party task session initiator certain details relating to a completed initiated task by a third party, which includes: 1) date, start time, end time, duration each task session; 2) location areas associated with each task session; 3) task actions requested; 4) number of photos/videos uploaded for each task session; and 5) confirmation of completion from the third part task initiator and associated user requested the task session.

16. The computer-implemented method as in claim 1, wherein the computer server is further configured to initiate payment from a user to a third party task initiator.

17. The computer-implemented method as recited in claim 16, wherein the computer server is further configured to automatically initiate payment to a third party task initiator upon completion of a task session by the third party task initiator.

18. A computer-implemented method for electronically prescribing a user defined task session to a third party via a communication network, comprising the steps:
prescribing a task session by a user, via user interaction with a user's computer device, to be initiated by a third party;
receiving in a remote computer server, via the communication network, the user prescribed task session;
sending from the remote computer server, via the communication network, the user prescribed task session to a designated third party;
receiving in a computer device associated with the designated third party, via the communication network, the prescribed task session to be initiated wherein the computer device associated with the third party is configured to:
display at least a portion of the prescribed task session to be initiated;
provide means for evidencing the prescribed task session has been initiated by the third party;
send a notification signal to the remote computer server, via the communication network, evidencing the prescribed task session has been initiated; and
receiving in the user's computer device a signal from the remote computer server, via the communication network, evidencing initiation of the prescribed task session by the designated third party responsive to the notification signal being received in the remote computer server, wherein the computer server utilizes one or more Artificial Intelligence (AI) techniques to determine a third party to be designated for receiving the prescribed task session from the computer server and to determine if a task session has been successfully completed by a third party.

19. The computer-implemented method as recited in claim 18, wherein the task session prescribed by the user includes a written description of the task session to be initiated and/or the means provided by the computer device of the third party for evidencing the prescribed task session has been initiated by the third party includes enabling the third party to input a written description evidencing the task has been initiated.

20. The computer-implemented method as recited in claim 19, wherein the user is enabled to provide follow-up requests relating to prior prescribed task session and/or including additional tasks to be initiated for a certain task session, subsequent to the certain task session being prescribed for initiation by a third party.
